(19) United States
(12) Patent Application Publication
(10) Pub. No.: US 2018/0011612 A1
(43) Pub. Date: Jan. 11, 2018

(54) A METHOD FOR LAYOUT AND SELECTION OF THE MENU ELEMENTS IN MAN-MACHINE INTERFACE

(71) Applicants: GÜRKAN ÖZTÜRK, Eskisehir (TR); ÖMER NEZiH GEREK, Eskisehir (TR); EMRE ÇiMEN, Eskisehir (TR)

(72) Inventors: GÜRKAN ÖZTÜRK, Eskisehir (TR); ÖMER NEZiH GEREK, Eskisehir (TR); EMRE ÇiMEN, Eskisehir (TR)

(21) Appl. No.: 15/545,316

(22) PCT Filed: Jan. 20, 2016
(86) PCT No.: PCT/TR2016/000009

§ 371 Date: Jul. 20, 2017

(30) Foreign Application Priority Data
Jan. 20, 2015 (TR) 2015/00633

(51) Int. Cl. G06F 3/0482; G06F 3/042

(52) U.S. Cl. CPC G06F 3/0482; G06F 3/0426; G06F 2203/04805

(57) ABSTRACT

The present invention relates to a method, which is operated by a control unit, and which enables the user to select any of the menu elements and switchover between menus at the main display menu of the machines desired to be interacted, or within an application installed on such device. By virtue of said method, the menu elements can be present on the display according to the level cluster of a cone-shaped function with any set of parameters, but also the positioning of the menu elements can also be performed according to the position of the pointer (M) after interacting with the machine. Upon interaction with the machine the corresponding menu element/elements is/are magnified according to the position of the pointer (M). The size of the elements deviated from due to movement of the pointer is reduced, while the elements converged to are magnified. Moreover, the position of the elements can be altered in the movement direction or a certain direction depending on the reverse direction according to the position of the pointer (M).

### TECHNICAL FIELD

The present invention relates to a method that ensures placement and selection of menu elements on the displays that can be used at all kinds of man-machine interface. An embodiment of this method is the virtual keyboard using the man-machine interface of the invention.

### PRIOR ART

Smart devices such as TVs, tablets, telephones etc. contain various menus on the man-computer interface in order to enable accessibility to various functions and such menus can be accessed via buttons on remote, the direction keys on the telephone or touching the respective menu on the touchscreen.

It is possible to encounter numerous articles, products and patents of “completely distinct” characteristics for the display menu positioning, which can generally be called as man-computer interface. The academic studies on the touchscreen keyboards used at the mobile devices are rather concerned about different types of use for such type of keyboards. Some articles studied the impact of the location of the keyboard on the display on writing performance, while some studied use of the technology that enables selecting the letter via sliding instead of stroke-based keyboard, while some others examined how the user experiences change with negative feedback.

Users of smartphones with small displays suffer from difficulty of writing correctly when inputting texts to their devices particularly due to small size of the menu elements, the keys of the keyboard in particular or to access the menu elements. Many smartphone users experience problems on writing local letters and switching from keyboard display to punctuation marks display. Inputting texts with smart devices further leads to health problems at thumb, palms and wrists at many users due to repeated tension. The primary health problems experienced are pain, ache, difficulty in grasping, reduction at thumb reach range, slowed finger movements and click-like sounds at the articulations. It is observed; however, that majority of the applications available fail to pay attention to such problems.

### Problems Solved with the Invention

The objective of the present invention is to realize a menu positioning and selection method that enables accurate access for the users to numerous menu element (e.g. keyboard letters, symbols, TV channels, temperature level etc.), in a small area. The method of the invention shall enable geometrical behaviour and selection of the elements of the menu according to the position of a pointer on the display of the said machine. Throughout this document, the term “pointer” is defined as a position marker and can be inputted by user with different perception methods. Such input systems can be achieved via touch of fingers on the touchscreen display or, in a more general sense, via perceiving and interpreting of any object (pen, remote, etc.) or hand/finger by means of any sensor of the device (e.g. location, angle, motion, pose, sound or shape sensor, camera, etc.). The menu elements are placed according to cone-shaped function level clusters to be disclosed in the document. Cone-shaped function centre can be stationary, or can also be determined according to the original position of the pointer. Such indication can be known geometrical shapes such as triangle, square, elliptical, etc. by virtue of the level clusters to be obtained according to different parameters to be assigned to the cone-shaped function, but also can be formed from richer geometrical curves. By virtue of such feature, the menu and keyboard layout and selection formed according to the method of the invention varies from the available technologies.

Another objective of the present invention is to realize a menu positioning and selection method that enables selection of the adaptive menu elements is achieved by sliding the finger, instead of clicking. Such feature shall enable the users to make more ergonomic and more accurate selections. Moreover, such menu has a flexible structure. For instance, the users can readily switchover from letters to punctuation marks.

Another objective of the present invention is to realize a menu positioning and selection method that enables the visually handicapped to use the menu and the keyboard. As the feedback at menu and keyboard inputs achieved by clicking on the menu cannot be made before key activation, the interfaces currently available are not suitable for use by the visually handicapped, but the menu positioning and selection method presented herein creates a difference also in this respect. In the method specifically designed for this, selection of elements works with motion of the dragged pointer and can be combined with “sound” data. In this manner, a feedback is provided through note and sound levels depending on the pointer position, ensuring that the users are directed to make accurate selection.

Another objective of the present invention is to form menu or keyboard compatible with smart watches. Smart watch users employ either speech to text technology or extremely inadequate methods due to small sized keys in order to input texts. Moreover, selection of the menu elements available at the watches is extremely challenging due to the size of the display. Menu elements/keyboard employing our menu positioning and selection philosophy solves this problem. Not only the users of smart devices with touchscreen display but also the smart TV users experience problems when surfing on the internet and texting. Some TV users even not prefer to use internet with TV solely due to such challenges. Technologies suggested herein shall enable the users to write faster. Furthermore, the TV interfaces to be created with suggested menu positioning shall also enable selection of menu elements more easily.

The menu or the keyboard designed according to the method disclosed herein also allows hybrid menus as it can be used “in conjunction” with other key input elements. For instance, while a keyboard with adaptive keys contain letters, another keypad used in combination can offer a keyboard comprising of figures.

### DETAILED DESCRIPTION OF THE INVENTION

A menu positioning and selection method realized in order to achieve the objective of the present invention is illustrated in the figures attached hereto, in which;

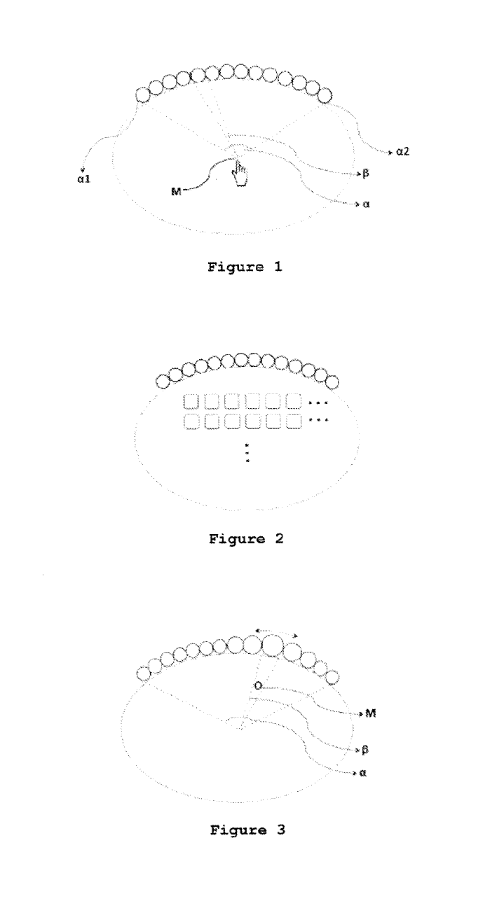

FIG. 1 shows a representative view of the menu elements positioned according to the level cluster of the cone-shaped function.

FIG. 2 shows a representative view of the other menu elements formed at a section other than the menu elements positioned according to the level cluster of the cone-shaped function.

FIG. 3 shows a representative view of zooming of the menu element to which the marker approaches and the left-right scrolling of other elements depending on the zoom ratio.

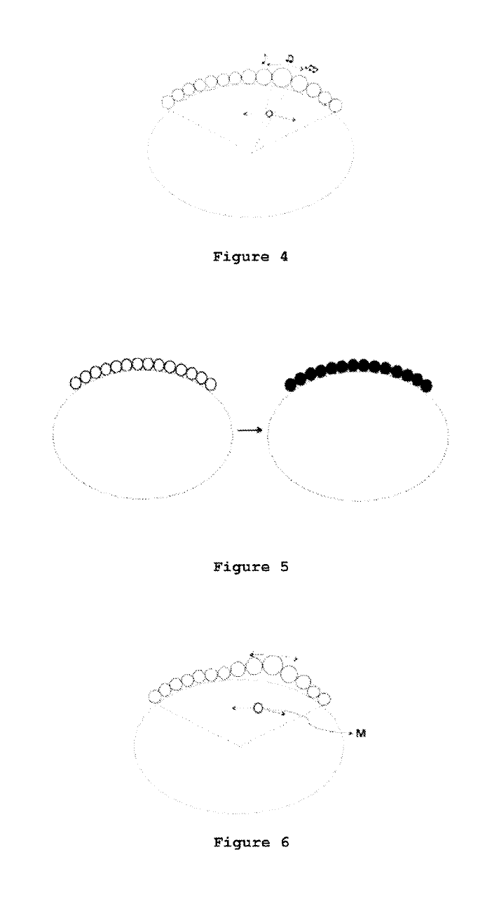

FIG. 4 shows a representative view that illustrates playing of sounds specific to that element upon accessing the zone of each menu element.

FIG. 5 shows a representative view that illustrates interchanging of menu elements with other elements.

FIG. 6 shows a representative view that illustrates upward scrolling of the menu elements positioned according to the level cluster of the cone-shaped function from the pointed zone.

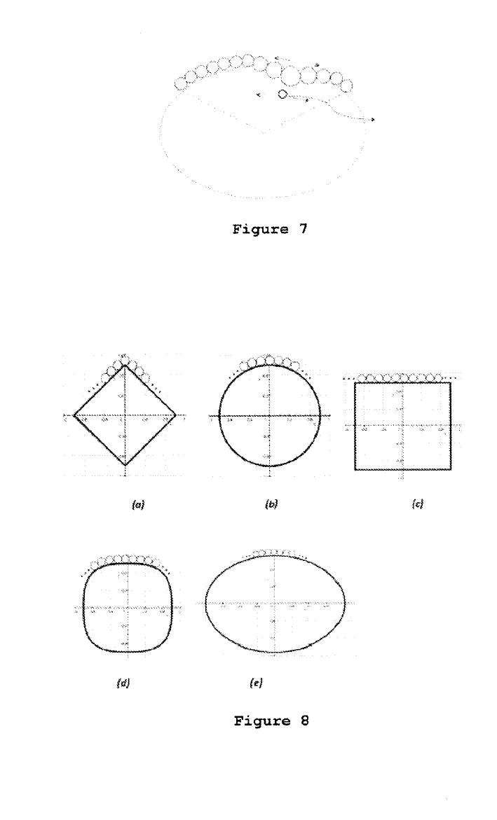

FIG. 7 shows a representative view that illustrates downward scrolling of the menu elements positioned according to the level cluster of the cone-shaped function from the pointed zone.

FIG. 8 shows representative views of the different level clusters of the cone-shaped function that might be formed with different parameters.

The coordinate, angle, magnitude and parts on the figures are enumerated individually, and the equivalents of the assigned numbers are provided hereunder.
M. Pointer
α. Total scattering angle
α1. Start angle
α2. End angle
β. Angle per menu element

The menu positioning and selection method of the invention, which is operated by a control unit and which enables the user to select any of the menu elements and switchover between menus at the main display menu of the smart devices/machine operating system, or within an application installed on such device essentially comprises the steps of,
Sensing the position of the pointer (M) on any display by means of a position sensor,
Positioning the menu elements according to a cone-shaped function level cluster identified with any parameter set,
Determining the centre of such cone-shaped function according to a fixed position or to the originating position of the pointer (M),
Creation of the menu elements positioned according to the level cluster of such cone-shaped function by a control unit and displaying of the same on said display,
Moving said menu element or at least one of the other menu elements towards any predetermined direction at a certain distance and/or changing size of the same by sensing the motion of the pointer (M) towards any of the menu elements.

By virtue of the method of the invention, the position of the pointer (M) sensed and interpreted by means of any sensor of the device (e.g. location, angle, motion, pose, sound or shape sensor, camera, etc.) though touch of fingers on the touchscreen display or, in a more general sense, of any object (pen, remote, etc.) or hand/finger enables selection input and offers menu flow systematics.

At the first step of the menu positioning and selection method of the invention, the position of the pointer (M) is detected. While such detection operation is ensured via resistive, capacitive, infrared or a touchscreen display featuring surface wave technology in an embodiment of the invention, such detection is performed by means of a sensor, such as a camera that enables detecting the position of the finger or any object in another embodiment of the invention. As said detection processes are available in the prior art, the method for such detection process is briefly summarized hereunder through various embodiments.

In a preferred embodiment of the invention, the smart device used can not only be devices with resistive/capacitive touchscreen display (e.g. smartphone/watch or tablet computer), but can also be a camera or any device with any integrated sensor (e.g. smart TV or another device with monitor). Menu input in touchscreen devices can be made through touch and motions of finger, while menu input at devices with integrated cameras or sensors can be made through visualization and feedback of the movement of the hand, finger or object depicted on the display without contacting the display.

After sensing the position of the pointer (M) that corresponds to a point on the display of such smart devices, and allowing input of data to the smart device, pre-determined menu elements are positioned according to a cone-shaped function level cluster identified with a parameter set, and the centre of said cone-shaped function is determined according to a fixed position or the originating position of the pointer (M).

In the next step, the control unit displays the menu elements (icons) positioned around according to a level cluster of the cone-shaped function according to a fixed centre on the display of said smart device or originating from the initial pointer (M) position. In an embodiment of the invention, said menu elements can be pre-determined menu elements such as volume on/off, accessing the applications, options for turning on the wireless connection and/or letters indicated on the keyboard. In another embodiment of the invention, on the other hand, the control unit can display the menu elements (e.g. keyboard keys) with a small graphical series (icons smaller than the menu elements to be displayed after interacting) on said display, if the size of the display is sufficient, prior to the activation of the element (prior to interacting the display) for running the activities of the element, which shall be disclosed later in detail. In other words, menu elements can be displayed as relatively smaller icons at the originate-up, and the menu icons in the vicinity of the option approached can be magnified after interacting with the display. In another embodiment of the invention, if the display size is small (e.g. smart watches) the image of such elements can only be visible after any activation (e.g. upon sensing the touch on the display).

In an embodiment of the invention the cone-shaped function mentioned in the descriptions given above is expressed with Equation 1.

g(x₁,x₂)=w₁(x₁□a₁)+w₂(x₂□a₂)°(|□₁(x₁□a₁)|^{p}+|□₂(x₂□a₂)|^{p})^{1/p}□□w_{1,2},x_{1,2}□R,□_{1,2}□R>0,□□R (Equation 1)

Some examples for the level clusters that the cone-shaped function expressed with Equation 1 can form with different parameters are presented hereunder and illustrated in FIG. 8.

The level cluster for the parameter w₁=0,w₂=0,a₁=0,a₂=0,l (=1, l l₂=1,p=1, l l=0 is illustrated in FIG. 8a.

The level cluster for the parameter w₁=0,w₂=0,a₁=0,a₂=0,□₁=1,□₂=1,p=2,□=0 is illustrated in FIG. 8b.

The level cluster for the parameter w₁=0,w₂=0,a₁=0,a₂=0,□₁=1,□₂=1,p=1000,□=0 is illustrated in FIG. 8c.

The level cluster for the parameter w₁=0,w₂=0,a₁=0,,a₂=0,l=1,/=1,p=10,/=0 is illustrated in FIG. 8d.

The level cluster for the parameter w₁=0,w₂=0,a₁=0,a₂=0,□₁=2,□₂=1,p=1,□=0 is illustrated in FIG. 8e.

In addition to the menu elements positioned according to the level cluster of the cone-shaped function as illustrated in FIG. 1, other menu elements can also be created at any section (preferably underneath) other than said menu elements by the control unit as illustrated in the FIG. 2. In this case, clicking process is executed in order to select a menu element illustrated at the underside. Selection method for said element can also be touching, pressing, selection through motion, etc. depending on the method of interaction. If sliding is used for interaction (that is to say when changing the pointed spot), the menu illustrated under side becomes invisible.

The motion is detected when said pointer (M) moves towards any of the menu elements, said menu element or at least one of the other menu elements is moved towards any predetermined direction at a certain distance and/or the size of said menu element or at least one of the other menu elements are changed by a certain factor (FIG. 3). In a preferred embodiment of the invention, when the element approached is dynamically activated, said element is magnified at a pre-determined size within the limits defining such element and the graphs thereto as proportional to the proximity to the pointer (M). The magnification process for the approached element is also active when scrolling the pointer (M) between the elements for selecting a new element in addition to approaching an element from the originating point of the pointer (M). During magnification process of the respective element, the spots pointed on the display (spots pressed) are detected when scrolling the pointer (M) and the respective element is magnified dynamically by means of a zooming function when scrolling the pointer (M) by the control unit according to the pre-determined values corresponding to such values. Upon accessing said element, the control unit detects whether the pointer (M) is at the coordinates of said element, and the said element is magnified by the control unit to have the pre-defined maximum size corresponding to such values at the memory of the control unit.

In a preferred embodiment of the invention, when the size of the approached element is altered by the control unit, the size of at least one of the other elements around the said element remains fixed or modified, preferably reduced. Likewise, the element approached is magnified also when navigating between the elements by scrolling the pointer (M) on the display, and the other elements around this element is kept at fixed size by the control unit or modified, preferably reduced, or the colour and transparency values are modified, thus drawing attention to the active menu element. Such size reduction operation can be modified as proportional to the proximity of the pointer (M) to said element. In this case, the control unit at the smart device continuously compares the variable position of the pointer (M) when approaching the element with the values calculated during the process or with pre-calculated values stored in its memory, and modify the size of said element depending on the pointer (M) position.

In an embodiment of the invention, the centre, the position of the said element approached can be modified towards the pointed spot (pressure point) during approach according to the ergonomics option at the application (FIG. 6 and FIG. 7). In an embodiment of the invention, said element deviates from the pressure point when the pointer (M) approaches or converges towards such point, while at least one of the elements around the said element can be moved by the control unit on the trajectories calculated according to the level cluster of a cone-shaped function as preferably proportional to the proximity of the pointer (M) to the respective element in the motion direction of the approached element or in reverse direction and/or towards left-right. In other words, in case the pointer (M) is moved in such direction diverging from the element for abandoning the selection for any menu element about to be selected, the size of said menu element can be reduced by the control unit and can be moved towards the centre at a direction diverging from the new selection element. Such divergence and convergence process (FIG. 6 and FIG. 7) can be performed when magnifying the desired element, when reducing the size of the elements other than said element or without performing such operations over the calculated trajectories according to the level cluster of a cone-shaped function.

In an embodiment of the invention, when scrolling the pointer (M), the size of the elements closest to the pointed spot is magnified (preferably larger than the other elements) by the control unit as proportional to the distance to the pointed spot. While the magnification at the element closest to the pointed spot is at the maximum level, the magnification rate of the other close elements in the vicinity of such element is lower than the approached element and is further smaller at the elements at distance from the approached element.

The elements other than the element/elements magnified as the pointed spot approaches are scrolled at a certain direction by the control unit depending on the movement according to the magnification rate of the magnified element. If the pointed spot is scrolled right, the menu elements at the concerned zone are scrolled left by the control unit, and if the pointed spot is scrolled left, then the menu elements are scrolled right (FIG. 3).

In another embodiment of the invention, the control unit generates a visual and/or audial feedback upon accessing the desired element. For instance, the colour, size and/or the image of the accessed element changes and an audible feedback is generated with a sound unique for such option (FIG. 4).

In a preferred embodiment of the invention, as the pointer (M) enters the definition limits of the element, the function for such element is activated by the control unit. For instance, any letter or symbol can be selected on the display. Moreover, after activation of said element, pre-defined sub-functions are activated repeatedly and the graphs for the same are illustrated on the interface of the smart device (machine) by the control unit. For example, when a letter is selected in keyboard case, the variations and/or capital letter versions of such letter peculiar to the language used (e.g. Turkish) can be reflected to the display as another element immediately above the selected element and can be offered for selection. In another embodiment of the invention, after activating an element (that is to say, when the pointer is above the respective element), the procedures corresponding to such element are created collectively as a new menu and the respective graphs are added to the interface. For instance, the probable words complementing the letters selected in keyboard can be presented from the display in such manner to ensure input with a single element in the menu, thus accelerating the text input by means of such completion.

In another embodiment of the invention, the instant when the pointer (M) enters into the definition limits of the element (that is to say when said element is activated) is perceived, and a new menu at one upper level is formed around said element by the control unit with identical visual/audio notification. In an embodiment of the invention, said upper level menu comprises of menu elements positioned around the activated element on the display of the smart device according to the level cluster of a cone-shaped function.

In a preferred embodiment of the invention, after the pointer (M) accesses to the respective element, when the pointer (M) is cancelled on said element (e.g. removing the finger, pre-defined cancelation movement etc.), such cancelation is perceived and the control unit executes the selection process for respective element. The selection operation can be performed at any level of said iterative formation. In other words, the selection operation can be performed by removing the finger from the initially accessed menu element or any of the new elements at the upper level formed around said element. In this manner, prior to confirmation of the selection process with the pointer (M) over the desired element, it is enabled to scroll the pointer (M) between determined elements according to the level cluster of a cone-shaped function, and navigating between upper menu elements.

In another preferred embodiment of the invention, the new option/s popping up for the accessed element are cancelled by obtaining the position data of the pointer (M) as the pointer (M) returns to a certain area (e.g. the point of origin).

In an embodiment of the invention, the menu input method disclosed above and traditional input methods available can co-exist on the same menu set. In other words, when selecting an element at the existing menus, the position of the pointer (M) is detected, and the control unit is capable of displaying the menu elements formed in advance and positioned around from that position or a fixed central position according to the level cluster of a cone-shaped function. For instance, the keypad of any telephone primarily offers “numeric keypad” for telephone use, an alternate letter keyboard set might be activated via a sliding motion when the finger is pressed any of the keys and the keyboard so activated can provide functions in the previously explained format, such as, magnification when approaching to an element/zooming in and out/colour and sound confirmations/navigation between elements and dynamic motion of the said element and the elements around such element. In this manner, the same keying zone can be used as multiple keyboards without any discrepancy.

In an embodiment of the invention, the left-right, up/down motions of the pointer (M) are also perceived in addition to the motion towards a menu element, thus ensuring conversion of the keys of the menu by the control unit, that is to say, conversion to other predetermined keys (FIG. 5). For instance, the letter pad available at the beginning of the keyboard application can be converted into a keypad comprising of different symbols after a pointer (M) sliding movement. In another embodiment of the invention, on the other hand, the control unit can provide (undo/redo) actions said previously performed at the menu or activation of customized shortcuts (delete, execute a certain procedure, etc.) via such movements. In another embodiment of the invention, on the other hand, direct access from the menu to another application or operating system elements can be ensured. For instance, running an application at the system or transition to an application that requires text input from the keyboard.

In an embodiment of the invention, the method of the invention can be used at the main display menu of any smart device operating system. Particularly at devices with small display such as smart watch, the main function of which is to present the time or health data, application icons (elements) arranged on the trajectory calculated around the point of contact display according to the level cluster of a cone-shaped function appear upon touching the display. Upon approaching such icons, the icons can move dynamically with the previously described magnification/zooming in and out/colour and sound confirmations/navigation between options. When selection is made by removing the finger from an icon, a control unit running the operating system of the smart device runs the application.

In another embodiment of the invention, the dynamic menu structure mentioned can be used as an option for a certain application. The application can process the selection inputted at this form in accordance with its own content.

1. A menu selection method, which is operated by a control unit, and which enables the user to select any of the menu elements and switchover between menus at the main display menu of the smart devices/machine operating system, or within an application installed on such device, and essentially comprising the step of,
sensing the position of the pointer (M) on any display by means of a position sensor,
characterized in comprising the process steps of,
positioning the menu elements according to a cone-shaped function level cluster identified with any parameter set,
determining the centre of such cone-shaped function according to a fixed position or to the originating position of the pointer (M),
creation of the menu elements positioned according to the level cluster of such cone-shaped function by a control unit and displaying of the same on said display, and
moving said menu element or at least one of the other menu elements towards any predetermined direction at a certain distance and/or changing size of the same by sensing the motion of the pointer (M) towards any of the menu elements.

2. A menu selection method according to claim 1, characterized in that, in the step of “Creation of the menu elements positioned according to the level cluster of such cone-shaped function by a control unit and displaying of the same on said display’, other menu elements are also formed by the control unit at a section other than the said menu elements.

3. A menu selection method according to claim 1, characterized in that, in the step of “Moving said menu element or at least one of the other menu elements towards any predetermined direction at a certain distance and/or changing size of the same by sensing the motion of the pointer (M) towards any of the menu elements” when the element approached is dynamically activated, said element is magnified at a pre-determined size within the limits defining such element and the graphs thereto as proportional to the proximity to the pointer (M).

4. A navigation method on the menu according to claim 1, characterized in that in case the pointer (M) is moved in such direction diverging from the element for abandoning the selection for any menu element about to be selected, the size of said menu element can be reduced by the control unit and can be moved towards the centre at a direction diverging from the new selection element.

5. A menu selection method according to claim 1, characterized in that, in the step of “Moving said menu element or at least one of the other menu elements towards any predetermined direction at a certain distance and/or changing size of the same by sensing the motion of the pointer (M) towards any of the menu elements”, the elements other than the element/elements magnified as the pointed spot approaches are scrolled right or left by the control unit depending on the movement according to the magnification rate of the magnified element.

6. A menu selection method according to claim 1, characterized in that, in the step of “Moving said menu element or at least one of the other menu elements towards any predetermined direction at a certain distance and/or changing size of the same by sensing the motion of the pointer (A) towards any of the menu elements”, the control unit generates a visual and/or audial feedback upon accessing any element.

7. A menu selection method according to claim 1, characterized in that, after the step of “Moving said menu element or at least one of the other menu elements towards any predetermined direction at a certain distance and/or changing size of the same by sensing the motion of the pointer (M) towards any of the menu elements”, as the pointer (M) enters the definition limits of the element, the function for such element is activated by the control unit.

8. A menu selection method according to claim 7, characterized in that, after activation of said element, pre-defined sub-functions are activated repeatedly and the graphs for the same are illustrated on the interface of the smart device (machine) by the control unit said.

9. A menu selection method according to claim 7, characterized in that, after activation of an element, the procedures corresponding to such element are created collectively as a new menu and the respective graphs are added to the interface.

10. A menu selection method according to claim 1 or 7, characterized in that, the instant when the pointer (M) enters into the definition limits of the element is perceived, and a new menu at one upper level is formed around said element by the control unit with identical visual/audio notification.

11. A menu selection method according to claim 7, characterized in that, after the pointer (M) accesses to the respective element, when the pointer (M) is cancelled, such cancelation is perceived and the control unit executes the selection process for respective element.

12. A menu selection method according to claim 7, characterized in that, the new option/s popping up for the accessed element are cancelled by the control unit by sensing the position of the pointer (M) as the pointer (M) returns to a certain area.

13. A menu selection method according to claim 7, characterized in that, when selecting an element at the existing menus, the position of the pointer (M) is detected, and the control unit is capable of displaying the menu elements formed in advance and positioned around from that position or a fixed central position according to the level cluster of a cone-shaped function.

14. A menu selection method according to claim 1, characterized in that, after the step of “Sensing the position of the pointer (M) on any display by means of a position sensor” the control unit can activate customized shortcuts by sensing the motions other than the movements towards a menu element.
